(19) United States
(12) Patent Application Publication
(10) Pub. No.: US 2026/0054620 A1
(43) Pub. Date: Feb. 26, 2026

(54) Seat

(71) Applicants: Hyundai Motor Company, Seoul (KR); Kia Corporation, Seoul (KR); Hyundai Transys Inc., Seosan-si (KR)

(72) Inventors: Mu Young Kim, Osan-Si (KR); Jong Min Park, Hwaseong-Si (KR); Dae Myoung Park, Hwaseong-Si (KR); Sung Ho Park, Hwaseong-Si (KR); Sang Woo Kim, Hwaseong-Si (KR); Yeon Soo Eo, Hwaseong-Si (KR); Min Ha Lee, Hwaseong-Si (KR); Min Sik Kim, Hwaseong-Si (KR); Da Yeong Kim, Hwaseong-Si (KR); Young Joo Cho, Hwaseong-Si (KR); Soo Beom Kwak, Hwaseong-Si (KR); Hee Dong Choi, Hwaseong-Si (KR); Seok Ju Gim, Hwaseong-Si (KR); Han Kyung Park, Hwaseong-Si (KR); Won Yeung Lee, Osan-Si (KR)

(21) Appl. No.: 19/045,651

(22) Filed: Feb. 5, 2025

(30) Foreign Application Priority Data
Aug. 26, 2024 (KR) 10-2024-0114622

(51) Int. Cl. B60N 2/30; B60N 2/10

(52) U.S. Cl. CPC B60N 2/3045; B60N 2/10; B60N 2/3009

(57) ABSTRACT

A seat comprises a base frame part, a cushion frame part provided at one side of the base frame part, a back frame part provided at one side of the base frame part and one side of the cushion frame part, a first cushion link having a first side rotatably coupled to the cushion frame part and a second side rotatably coupled to the base frame part, a first back link having a first side rotatably coupled to the back frame part and a second side rotatably coupled to the base frame part, and a connection link having a first side rotatably coupled to the first cushion link and a second side rotatably coupled to the first back link.

### CROSS-REFERENCE TO RELATED APPLICATION

This application claims priority to and the benefit of Korean Patent Application No. 10-2024-0114622 filed in the Korean Intellectual Property Office on Aug. 26, 2024, the entire contents of which are incorporated herein by reference.

### TECHNICAL FIELD

The present disclosure relates to a seat, and more particularly, to a seat capable of changing in posture.

### BACKGROUND

Vehicle seats in are mainly designed to focus on placing occupants in the vehicle seats. However, in the case of multipurpose vehicles, such as purpose-built vehicles (PBVs), with various uses, seats designed for placing occupants in the seats for other situations may be useful.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a folding structure of a seat. A seat may comprise: a base frame, a cushion frame provided at a side of the base frame, a back frame, a first cushion link having a first side rotatably coupled to the cushion frame and a second side rotatably coupled to the base frame having a first side rotatably coupled to the back frame and a second side rotatably coupled to the base frame having a first side rotatably coupled to the first cushion link and a second side rotatably coupled to the first back link.

A seat may also, or alternatively, comprise: a base frame, a cushion frame provided at a side of the base frame, a back frame, a first cushion link having a first side rotatably coupled to the cushion frame and a second side rotatably coupled to the base frame, a second cushion link having a first side rotatably coupled to the cushion frame and a second side rotatably coupled to the base frame, a first back link having a first side rotatably coupled to the back frame and a second side rotatably coupled to the base frame, and a connection link having a first side rotatably coupled to the first cushion link and a second side rotatably coupled to the first back link. The seat may be configured to switch between a first state and a second state. In the first state, the first cushion link and the second cushion link are configured so that the cushion frame extends in a horizontal direction to support an occupant sitting in the seat. In the second state, the first cushion link and the second cushion link are configured so that the cushion frame extends in a vertical direction.

A vehicle may comprise the seat disclosed herein.

These and other features and advantages are described in greater detail below.

### BRIEF DESCRIPTION OF THE DRAWINGS

FIG. 1 is a perspective view of a seat according to the present disclosure, i.e., a view illustrating a state of the seat in a state in which an occupant may be seated in the seat.

FIG. 2 is a perspective view of the seat according to the present disclosure, i.e., a view illustrating a state of the seat when a cushion frame part is rotated so that the cushion frame part in FIG. 1 extends in an upward/downward direction.

FIG. 3 is a view illustrating frame parts and links of the seat according to the present disclosure.

FIG. 4 is a side view illustrating a relative positional relationship between the frame parts and the links when the seat is in the state in FIG. 1.

FIG. 5 is a side view illustrating a relative positional relationship between the frame parts and the links when the seat is in the state in FIG. 2.

### DETAILED DESCRIPTION

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Existing seats may not efficiently use space or allow for most efficient use of space. A seat may be designed to occupy a minimum/reduced volume in case that the vehicle will also be used to load items into the vehicle and then transport the items.

Hereinafter, a seat according to the present disclosure will be described with reference to the drawings.

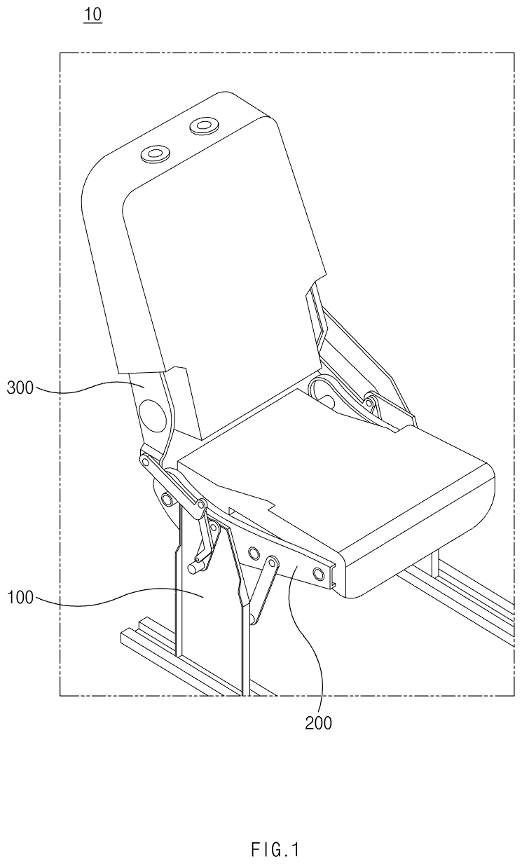

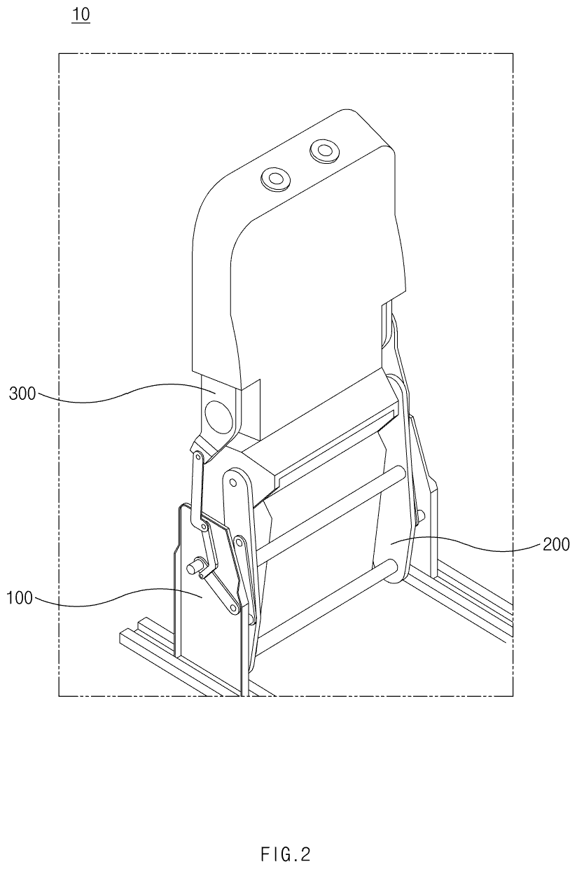

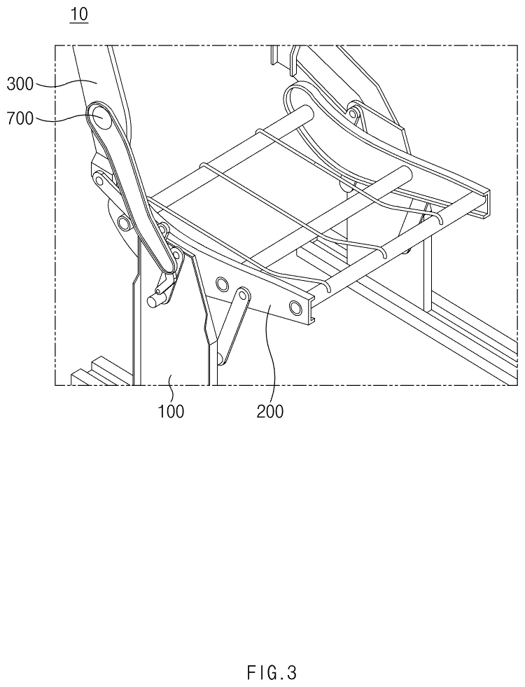

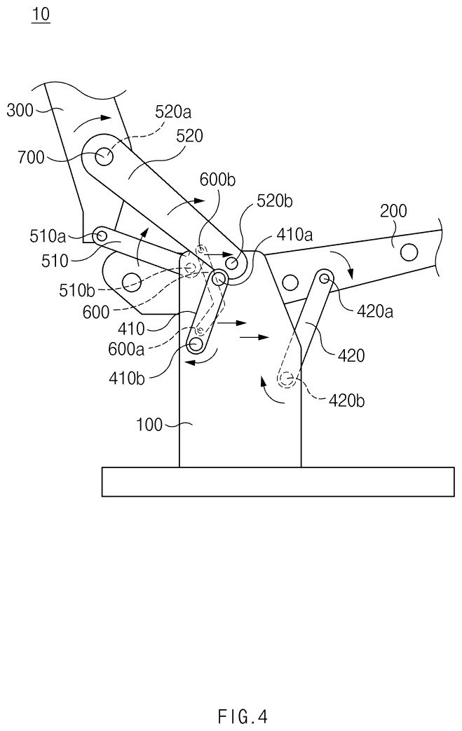

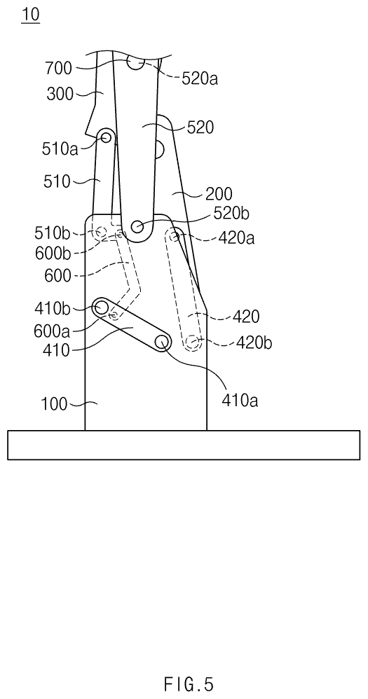

FIG. 1 is a perspective view of a seat according to the present disclosure, i.e., a view illustrating a state of the seat in a state in which an occupant may be seated in the seat, and FIG. 2 is a perspective view of the seat according to the present disclosure, i.e., a view illustrating a state of the seat when a cushion frame part (e.g., a cushion frame herein) is rotated so that the cushion frame part in FIG. 1 extends in an upward/downward direction. FIG. 3 is a view illustrating frame parts (e.g., frames herein) and links of the seat according to the present disclosure, and FIG. 4 is a side view illustrating a relative positional relationship between the frame parts and the links when the seat is in the state in FIG. 1. FIG. 5 is a side view illustrating a relative positional relationship between the frame parts and the links when the seat is in the state in FIG. 2.

The seat according to the present disclosure may be a seat for a vehicle. Therefore, the term ‘ground surface’ used in the present specification needs to be understood as a concept including a floor surface of the vehicle.

With reference to the drawings, a seat 10 according to the present disclosure may include base frame part(s) 100 (e.g., base frame(s)). The base frame part 100 may protrude upward from a floor/floor surface (e.g., of a vehicle) and be configured to fix the seat 10 to the floor/floor surface. For example, the base frame part 100 may be fixed relative to the floor/floor surface.

The seat 10 according to the present disclosure may include cushion frame part(s) 200 (e.g., cushion frame(s) herein) provided at one side of the base frame parts 100 (e.g., between two opposing base frame parts 100). For example, the cushion frame part 200 may be positioned in an upper region of the base frame part 100. With reference to FIGS. 1, 2, and 4, the cushion frame part 200 may be configured to constitute a frame of a cushion region in which an occupant's buttocks may be seated when the occupant is seated in the seat.

The seat 10 may further include back frame part(s) 300 (e.g., back frame(s)) provided at one side of the base frame parts 100 and one side of the cushion frame parts 200. As illustrated in FIGS. 1, 2, and 4, the back frame part 300 may be positioned rearward of the cushion frame part 200 (e.g., and the base frame parts 100) in a state in which the occupant may be seated in the seat 10 (e.g., if the seat 10 is configured to support an occupant sitting in the seat 10). A direction in which the occupant is intended to face when the occupant is seated in the seat 10 is defined as a forward direction, and a direction opposite to the forward direction is defined as a rearward direction. The back frame part 300 may constitute a frame of a backrest region (e.g., a frame of a backrest) which may support the occupant's back when the occupant is seated in the seat.

The cushion frame part 200 and the back frame part 300 may be configured to be movable relative to the base frame part 100. The seat 10 may further include a plurality of links that enables the cushion frame part 200 and the back frame part 300 to move along predetermined trajectories relative to the base frame part 100. A movement of the cushion frame part 200 and a movement of the back frame part 300 may be restricted and/or defined by the links.

With reference to FIGS. 4 and 5, the seat 10 according to the present disclosure may include a first cushion link 410 having a first side 410a rotatably coupled to the cushion frame part 200 and a second side 410b rotatably coupled to the base frame part 100, a first back link 510 having a first side 510a rotatably coupled to the back frame part 300 and a second side 510b rotatably coupled to the base frame part 100, and a connection link 600 having a first side 600a rotatably coupled to the first cushion link 410 and a second side 600b rotatably coupled to the first back link 510. A relative motion of the cushion frame part 200 and a relative motion of the back frame part 300 to the base frame part 100 may be restricted/defined by the connection between the first cushion link 410, the first back link 510, and the connection link 600.

With continued reference to FIGS. 4 and 5, the seat 10 according to the present disclosure may further include a second cushion link 420 having a first side 420a rotatably coupled to the cushion frame part 200 and a second side 420b rotatably coupled to the base frame part 100. The second side 420b of the second cushion link 420 may be positioned forward (on the base frame part 100) relative to the second side 410b of the first cushion link 410. The first side 420a of the second cushion link 420 may be positioned forward (on the cushion frame part 200) relative to the first side 410a of the first cushion link.

As illustrated in FIG. 4, the first side 420a of the second cushion link 420 may be positioned forward of the first side 410a of the first cushion link 410 in a state in which the first cushion link 410 and the second cushion link 420 are rotated so that the seat 10 is placed in a state in which the occupant may be seated in the seat 10 and/or the seat 10 is configured to support an occupant sitting and/or the cushion frame part 200 is in an orientation configured to support an occupant sitting in the seat (hereinafter, referred to as a ‘first state’). The state may also be configured to be in a state in which the cushion frame part 200 extends (e.g., is rotated relative to extend) in the upward/downward direction (e.g., instead of the horizontal direction of the first state, such that the cushion frame part 200 extends in an orientation normal to the orientation of the cushion frame part 200 in the first state, as shown in FIG. 5). The state in which the cushion frame part 200 extends in the upward/downward direction is referred to herein as a ‘second state’.

With reference to FIGS. 4 and 5, during a process in which the seat 10 switches from the first state to the second state, the first cushion link 410 may about the second side 410b of the first cushion link 410 such that the first side 410a of the first cushion link 410 moves forward and down. The second cushion link 420 may rotate about the second side 420b of the second cushion link 420 such that the first side 420a of the second cushion link 420 moves rearward. During/by the process in which the posture of the seat 10 switches from the first state to the second state, a rotation center of the cushion frame part 200 may be positioned between the first side 410a of the first cushion link 410 and the second side 420b of the second cushion link 420, which may minimize a degree to which the cushion frame part 200 moves in the forward/rearward direction during the process in which the posture of the seat changes. If the first cushion link 410 and the second cushion link 420 are rotated/configured so that the seat is in the first state (e.g., the seat is in the state in which the occupant may be seated in the seat), the first side 410a of the first cushion link 410 may be provided to overlap the base frame part 100, and the first side 420a of the second cushion link 420 may be spaced apart forward from the base frame part 100 when the seat is viewed in a leftward/rightward direction intersecting the forward/rearward direction and the upward/downward direction. In contrast, as illustrated in FIG. 5, in the second state, the first side 410a of the first cushion link 410 and the first side 420a of the second cushion link 420 may be provided to overlap the base frame part 100 when the seat is viewed in the leftward/rightward direction. As illustrated in FIG. 5, in the state in which the first cushion link 410 and the second cushion link 420 are rotated/configured so that the seat is in the second state, the first side 420a of the second cushion link 420 may be positioned above the first side 410a of the first cushion link 410.

A distance between the first side 420a and the second side 420b of the second cushion link 420 may be longer than a distance between the first side 410a and the second side 410b of the first cushion link 410. In this case, during the process in which the state of the seat 10 changes, a rotation radius of the second cushion link 420 about the second side 420b of the second cushion link 420 may be larger than a rotation radius of the first cushion link 410 about the second side 410b of the first cushion link 410.

The seat 10 according to the present disclosure may include a second back link 520 in addition to the first back link. The seat 10 according to the present disclosure may further include the second back link 520 having a first side 520a rotatably coupled to the back frame part 300 and a second side 520b rotatably coupled to the base frame part 100. Regardless of the state of the seat 10, the first side 520a of the second back link 520 may be provided above the first side 510a of the first back link 510, and the second side 520b of the second back link 520 may be provided forward of a second side 510b of the first back link 510. In the first state, an angle θ₂, which is defined between the floor/floor surface and a straight line that connects the first side 520a and the second side 520b of the second back link 520, may be larger than an angle θ₁ defined between the floor/floor surface of a straight line that connects the first side 510a and the second side 510b of the first back link 510. In case that the first back link 510 and the second back link 520 are provided to have the above-mentioned features, the back frame part 300 may entirely move forward during the process in which the seat 10 switches from the first state to the second state (e.g., in the second state). Therefore, according to the present disclosure, when the seat 10 switches from the first state to the second state (e.g., if the seat 10 is in the second state), a space occupied by the seat 10 (e.g., in the forward/rearward direction and/or a floor footprint/projection on the floor/floor surface) may be minimized.

With reference to FIG. 4, in the first state, the second side 600b of the connection link 600 may be provided forward of and above the second side 510b of the first back link 510. If the seat 10 switches from the first state to the second state, the second side 600b of the connection link 600 may rotate about the second side 510b of the first back link 510 and move downward to press the first cushion link 410 so that the first cushion link 410 moves downward relative to the second side 420b. In the first state, the first side 600a of the connection link 600 may be provided below the first side 410a of the first cushion link 410.

The seat 10 according to the present disclosure may include a recliner 700 configured to selectively fix the back frame part 300. For example, as illustrated in the drawings, the recliner 700 may be provided in a region in which the back frame part 300 and the second back link 520 are connected rotatably (e.g., at a same axial position as the first side 520a of the second back link 520). The recliner 700 may allow for a fixed state i) in which the back frame part 300 and the second back link 520 are fixed to each other and free state ii) in which the back frame part 300 and the second back link 520 may rotate relative to each other to be reversibly repeated. However, unlike the configuration illustrated in the drawings, the recliner 700 may be provided in another region as long as the region is a region in which two components are rotatably coupled to each other and able to be fixed in orientation or rotatable in orientation relative to each other. For example, the recliner 700 may also, or alternatively, be provided in a region in which the first back link 510 and the base frame part 100 are connected rotatably. The recliner 700 may be substituted with and/or comprise a locking member (e.g., such as a latch member).

Hereinafter, a method of operating the seat 10 according to the present disclosure will be described.

In the first state (e.g., as illustrated in FIG. 4), the recliner 700 (e.g., if present) may be decoupled to allow for rotation to the second state as illustrated in FIG. 5. Thereafter, when the back frame part 300 is rotated forward, the second side 510b, of the first back link 510, which is connected to the back frame part 300, and the second side 520b of the second back link 520 are rotated, and the connection link 600 connected to the first back link 510 is rotated while moving forward. In addition, the first cushion link 410, to which the first side 600a of the connection link 600 is coupled, rotates, and the cushion frame part 200 connected to the first cushion link 410 also rotates. The second cushion link 420 connected to the cushion frame part 200 also rotates, such that the components of the seat 10 are moved from the first state to the second state.

According to the present disclosure, a motion of the cushion frame part 200 and a motion of the back frame part 300 may operate in conjunction with each other by means of coupling structures between the frame parts and the links. If the seat 10 switches from the first state to the second state, the back frame part 300 may move forward, the cushion frame part 200 may stand in the upward/downward direction while moving rearward, and the back frame part 300 and the cushion frame part 200 may overlap each other in the forward/rearward direction, such that the space occupied by the seat 10 in the forward/rearward direction (e.g., a footprint on the floor/floor surface) may be minimized/reduced. Therefore, in the case of the vehicle equipped with the seat 10 according to the present disclosure, the utilization of the internal space may be maximized.

The present disclosure has been made in an effort to propose a new structure capable of minimizing a volume of a space occupied by a seat for a vehicle in comparison with the related art.

In order to achieve the above-mentioned object, one aspect of the present disclosure provides a seat including: a base frame part; a cushion frame part provided at one side of the base frame part; a back frame part provided at one side of the base frame part and one side of the cushion frame part; a first cushion link having a first side rotatably coupled to the cushion frame part and a second side rotatably coupled to the base frame part; a first back link having a first side rotatably coupled to the back frame part and a second side rotatably coupled to the base frame part; and a connection link having a first side rotatably coupled to the first cushion link and a second side rotatably coupled to the first back link.

The seat may further include: a second cushion link having a first side rotatably coupled to the cushion frame part and a second side rotatably coupled to the base frame part, in which the second side of the second cushion link is provided forward of the second side of the first cushion link.

In a state in which the first cushion link and the second cushion link are rotated so that the seat is in a state in which an occupant is capable of being seated in the seat, the first side of the second cushion link may be positioned forward of the first side of the first cushion link.

In a state in which the first cushion link and the second cushion link are rotated so that the cushion frame part extends in an upward/downward direction, the first side of the second cushion link may be positioned above the first side of the first cushion link.

In a state in which the first cushion link and the second cushion link are rotated so that the seat is in a state in which an occupant is capable of being seated in the seat, the first side of the first cushion link may be provided to overlap the base frame part, and the first side of the second cushion link may be spaced apart forward from the base frame part when the seat is viewed in a leftward/rightward direction.

In a state in which the first cushion link and the second cushion link are rotated so that the cushion frame part extends in an upward/downward direction, the first side of the first cushion link and the first side of the second cushion link may be provided to overlap the base frame part when the seat is viewed in the leftward/rightward direction.

The seat may further include: a second back link having a first side rotatably coupled to the back frame part and a second side rotatably coupled to the base frame part, in which the first side of the second back link is provided above the first side of the first back link.

The second side of the second back link may be provided forward of the second side of the first back link.

In a state in which the first cushion link and the second cushion link are rotated so that the seat is in a state in which an occupant is capable of being seated in the seat, the second side of the connection link may be provided forward of and above the second side of the first back link.

In the state in which the first cushion link and the second cushion link are rotated so that the seat is in the state in which the occupant is capable of being seated in the seat, the first side of the connection link may be provided below the first side of the first cushion link.

A distance between the first side and the second side of the second cushion link may be longer than a distance between the first side and the second side of the first cushion link.

In a state in which the first cushion link and the second cushion link are rotated so that the seat is in a state in which an occupant is capable of being seated in the seat, an angle θ2 defined between a ground surface and a straight line, which connects the first side and the second side of the second back link, may be larger than an angle θ1 defined between the surface and a straight line that connects the first side and the second side of the first back link.

According to the present disclosure, the volume of the space occupied by the seat for a vehicle may be minimized, which may improve the utilization of the internal space of the vehicle in comparison with the related art.

The present disclosure has been described with reference to the limited examples and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A seat comprising:
a base frame;
a cushion frame provided at a side of the base frame;
a back frame;
a first cushion link having a first side rotatably coupled to the cushion frame and a second side rotatably coupled to the base frame;
a first back link having a first side rotatably coupled to the back frame and a second side rotatably coupled to the base frame; and
a connection link having a first side rotatably coupled to the first cushion link and a second side rotatably coupled to the first back link.

2. The seat of claim 1, further comprising:
a second cushion link having a first side rotatably coupled to the cushion frame and a second side rotatably coupled to the base frame,
wherein the second side of the second cushion link is provided forward of the second side of the first cushion link.

3. The seat of claim 2, wherein, in a first state in which the first cushion link and the second cushion link are configured so that the cushion frame is in an orientation configured to support an occupant sitting in the seat, the first side of the second cushion link is positioned forward of the first side of the first cushion link.

4. The seat of claim 3, wherein, in a second state in which the first cushion link and the second cushion link are configured so that the cushion frame extends in an vertical direction perpendicular to the orientation of the cushion frame in the first state, the first side of the second cushion link is positioned above the first side of the first cushion link.

5. The seat of claim 2, wherein, in a first state in which the first cushion link and the second cushion link are configured so that the cushion frame is in an orientation configured to support an occupant sitting in the seat, from a side perspective of the seat. the first side of the first cushion link overlaps the base frame, and the first side of the second cushion link is spaced apart forward from the base frame.

6. The seat of claim 5, wherein, in a second state in which the first cushion link and the second cushion link are configured so that the cushion frame extends in an vertical direction perpendicular to the orientation of the cushion frame in the first state, from the side perspective of the seat, the first side of the first cushion link and the first side of the second cushion link overlap the base frame.

7. The seat of claim 2, further comprising:
a second back link having a first side rotatably coupled to the back frame and a second side rotatably coupled to the base frame,
wherein the first side of the second back link is above the first side of the first back link.

8. The seat of claim 7, wherein the second side of the second back link is positioned forward of the second side of the first back link.

9. The seat of claim 2, wherein, in a first state in which the first cushion link and the second cushion link are configured so that the cushion frame is in an orientation configured to support an occupant in the seat, the second side of the connection link is positioned forward of and above the second side of the first back link.

10. The seat of claim 9, wherein, in the first state, the first side of the connection link is below the first side of the first cushion link.

11. The seat of claim 2, wherein a distance between the first side and the second side of the second cushion link is greater than a distance between the first side and the second side of the first cushion link.

12. The seat of claim 7, wherein, in a first state in which the first cushion link and the second cushion link are configured so that the cushion frame is in an orientation configured to support an occupant in the seat, an angle θ₂, between a surface on which the seat is configured to be installed and a line connecting the first side and the second side of the second back link, is larger than an angle θ₁, between the surface and a line connecting the first side and the second side of the first back link.

13. A seat comprising:
a base frame;
a cushion frame provided at a side of the base frame;
a back frame;
a first cushion link having a first side rotatably coupled to the cushion frame and a second side rotatably coupled to the base frame;
a second cushion link having a first side rotatably coupled to the cushion frame and a second side rotatably coupled to the base frame;
a first back link having a first side rotatably coupled to the back frame and a second side rotatably coupled to the base frame; and
a connection link having a first side rotatably coupled to the first cushion link and a second side rotatably coupled to the first back link,
wherein the seat is configured to switch between a first state and a second state;
wherein, in the first state, the first cushion link and the second cushion link are configured so that the cushion frame extends in a horizontal direction to support an occupant sitting in the seat; and
wherein, in the second state, the first cushion link and the second cushion link are configured so that the cushion frame extends in a vertical direction.

14. The seat of claim 13, wherein, in the first state, the first side of the second cushion link is positioned forward of the first side of the first cushion link.

15. The seat of claim 14, wherein, in the second state, the first side of the second cushion link is positioned above the first side of the first cushion link.

16. The seat of claim 13, wherein, in the first state, from a side perspective of the seat, the first side of the first cushion link overlaps the base frame, and the first side of the second cushion link is spaced apart forward from the base frame.

17. The seat of claim 16, wherein, in the second state, from the side perspective of the seat, the first side of the first cushion link and the first side of the second cushion link overlap the base frame.

18. A vehicle comprising the seat of claim 1.
